(19) United States
(12) Patent Application Publication
(10) Pub. No.: US 2020/0253248 A1
(43) Pub. Date: Aug. 13, 2020

(54) STARCH PROCESSED WITH OIL OR FAT, COATING MATERIAL FOR DEEP-FRIED FOOD, FOOD AND METHOD FOR MANUFACTURING FOOD USING THE SAME

(71) Applicant: J-OIL MILLS, INC., Tokyo (JP)

(72) Inventors: Shogo KAWAI, Tokyo (JP); Ayuna MIZUSHINA, Tokyo (JP); Masahiro INOUE, Tokyo (JP)

(21) Appl. No.: 16/642,681

(22) PCT Filed: Jul. 20, 2018
(86) PCT No.: PCT/JP2018/027258

§ 371 Date: Feb. 27, 2020

(30) Foreign Application Priority Data
Sep. 27, 2017 (JP) 2017-186545

(51) Int. Cl. A23L 7/157; A23L 29/219; A23P 20/10

(52) U.S. Cl. CPC A23L 7/157; A23V 2002/00; A23P 20/10; A23L 29/219

(57) ABSTRACT

Provided is a starch processed with oil or fat obtainable by processing a composition with oil or fat, in which the composition contains a component (A): starch having a degree of swelling in cold water of higher than 1 and lower than 3.5, a component (B): starch having a degree of swelling in cold water of equal to or higher than 3.5 and equal to or lower than 40, a component (C): edible oil or fat, and a component (D): a protein material, and a mixing amount of the component (B) with respect to 100 parts by mass of the component (A) in the composition is equal to or greater than 0.03 parts by mass and equal to or smaller than 7 parts by mass.

### TECHNICAL FIELD

The present invention relates to starch processed with oil or fat, a coating material for a deep-fried food, a food and a method for manufacturing the food using the same.

### BACKGROUND ART

As a coating material for foods such as deep-fried foods, wheat flour with a low gluten content has been mainly used. However, because a fried ingredient and the coating have insufficient adhesion properties after being fried, the coating is easily peeled from the ingredient, which leads to deteriorations of appearance and texture and a decrease in product value in some cases.

In order to solve the problem, a method of mixing a starch processed with oil or fat and a pregelatinized starch with the coating material has been suggested. The starch processed with oil or fat is a starch obtainable by mixing a starch with edible oil or fat, or, oil or fat analogs and then drying or heating the mixture.

Patent Document 1 (Japanese Unexamined Patent Publication No. 62-143663) describes a technique of adding a specific amount of a starch processed with oil or fat, a specific amount of a pregelatinized starch, and/or a specific amount of pregelatinized cereal powder to a coating material for deep-fried foods. According to Patent Document 1, by the technique, appropriate viscosity is obtained in a case where the coating material is used as batter, and the amount of the coating material attached to an ingredient is sufficiently increased, thus a deep-fried food is obtained in which a coating is attached to an ingredient at a high ratio, and the adhesion properties between the ingredient and the coating is also excellent.

Furthermore, Patent Document 2 (Japanese Unexamined Patent Publication No. 2009-284827) describes a technique relating to a batter mixture for freeze-dried Tempura containing a specific amount of a starch processed with oil or fat and at least one kind of component selected from a thickener and a pregelatinized cereal powder and starch. According to Patent document 2, by the technique, freeze-dried Tempura, which is excellently restored in hot water and recovers excellent texture and appearance in a case where boiling water is poured thereon, can be obtained through a simple process with excellent manufacturing efficiency.

### RELATED DOCUMENT

### Patent Document

[Patent Document 1] Japanese Unexamined Patent Publication No. 62-143663

[Patent Document 2] Japanese Unexamined Patent Publication No. 2009-284827

### SUMMARY OF THE INVENTION

### Technical Problem

However, even though the materials described in the above patent documents are used as a coating material, in order to provide foods which are excellent in the adhesion properties between a coating and an ingredient and has a soft inner coating and an outer coating having preferable texture that feels natural, a further improvement is required.

### Solution to Problem

According to the present invention, there is provided a starch processed with oil or fat obtainable by processing a composition with oil or fat, in which the composition contains components (A) a starch having a degree of swelling in cold water of higher than 1 and lower than 3.5, (B) a starch having a degree of swelling in cold water of equal to or higher than 3.5 and equal to or lower than 40, (C) an edible oil or fat, and (D) a protein material, and a mixing amount of the component (B) with respect to 100 parts by mass of the component (A) in the composition is equal to or greater than 0.03 parts by mass and equal to or smaller than 7 parts by mass.

According to the present invention, there is provided a coating material for deep-fried foods containing the starch processed with oil or fat of the present invention.

Furthermore, according to the present invention, there is provided a food obtainable by using the coating material for deep-fried foods of the present invention.

According to the present invention, there is provided a food containing an ingredient, a coating material (I) that is provided on the outside of the ingredient, and a coating material (II) that is provided on the outermost side, in which the coating material (I) contains the starch processed with oil or fat of the present invention, and the coating material (II) substantially does not contain the starch processed with oil or fat of the present invention.

According to the present invention, there is provided a method for manufacturing a food, including attaching a coating material (I), which contains the starch processed with oil or fat of the present invention, to the outside of an ingredient, and attaching a coating material (II), which substantially does not contain the starch processed with oil or fat of the present invention, to the outermost side of a food after the attaching the coating material (I).

Random combinations of the above constitutions and those obtainable by embodying the invention by modifying methods, devices, and the like are also effective as aspects of the present invention.

For example, according to the present invention, there is provided a method for manufacturing a coating material for deep-fried foods, including obtaining a starch processed with oil or fat by processing the composition containing the components (A) to (D) with oil or fat and obtaining a coating material for deep-fried foods that is a predust or batter mixed with the starch processed with oil or fat.

### Advantageous Effects of Invention

According to the present invention, it is possible to provide a food which is excellent in the adhesion properties between a coating and an ingredient and has a soft inner coating and an outer coating having preferable texture that feels natural.

### DESCRIPTION OF EMBODIMENTS

Hereinafter, embodiments of the present invention will be described based on specific examples. One kind of each of the following components can be used singly, or two or more kinds of the following components can be used in combination.

(Starch Processed with Oil or Fat)

In the present embodiment, the starch processed with oil or fat refers to a starch material produced through a process which includes adding edible oil or fat, or, oil or fat analogs to a raw material starch and has an operation of performing mixing and heating after the aforementioned step.

In the present embodiment, being preferable in terms of the texture of a layer of a coating contacting an ingredient means a state where the layer of the coating contacting the ingredient does not feel hard or slimy, and the crispiness of the layer of the coating that does not contact the ingredient or the juiciness of the ingredient is not impaired.

Furthermore, in the present embodiment, “coating material for deep-fried foods” is simply referred to as “coating material” as well.

In the present embodiment, the starch processed with oil or fat is obtainable by processing a composition containing the following components (A) to (D) with oil or fat, in which a mixing amount of the component (B) with respect to 100 parts by mass of the component (A) in the composition is equal to or greater than 0.03 parts by mass and equal to or smaller than 7 parts by mass.

(A) Starch having a degree of swelling in cold water of higher than 1 and lower than 3.5

(B) Starch having a degree of swelling in cold water of equal to or higher than 3.5 and equal to or lower than 40

(C) Edible oil or fat

(D) Protein material

In the starch processed with oil or fat of the present embodiment, the composition contains, as a raw material starch, the components (A) and (B) having different degrees of swelling in cold water at a specific ratio and further contains (C) and (D). According to the present embodiment, the starch processed with oil or fat is used which is obtainable by processing the composition containing the components (A) to (D) with oil or fat, so it is possible to obtain a food excellent in the adhesion properties between a coating and an ingredient. Furthermore, the food obtainable by the present embodiment has an inner coating having preferable softness and an outer coating having preferable texture that feels natural.

More specifically, the starch processed with oil or fat of the present embodiment is obtainable by processing the composition, which contains the components (A) and (B) having different degrees of swelling in cold water at a specific ratio and further contains the components (C) and (D), with oil or fat. Therefore, excellent adhesion properties between a coating and an ingredient can be obtained. Through examinations, the inventors of the present invention have found that in a case where an attempt is made to improve the adhesion properties between a coating and an ingredient, sometimes the texture of the coating becomes excessively hard, or the texture of the coating varies between the side of the coating close to the ingredient and the outer side of the coating, and hence the overall texture of the coating brings a feeling of strangeness. Therefore, in order to improve the balance between the excellent adhesion properties, which are exhibited between a coating and an ingredient, and the preferable texture of the entirety of the coating, the inventors of the present invention further carried out examinations. As a result, it has been revealed that in a case where the starch processed with oil or fat constituted as above is used, the layer contacting the ingredient does not become excessively hard, and a difference of the texture in the coating layer between the side close to the ingredient and the outer side can be suppressed.

Hereinafter, each of the components mixed with the starch processed with oil or fat will be described.

(Component (A))

The component (A) is a starch having a degree of swelling in cold water of equal to or higher than 1 and lower than 3.5. More specifically, from the viewpoint of making it difficult for the texture of a coating to vary between the side close to an ingredient and the outer side, the degree of swelling in cold water of the component (A) is higher than 1, preferably equal to or higher than 1.5, more preferably equal to or higher than 1.8, even more preferably equal to or higher than 2.0, still more preferably equal to or higher than 2.2, and yet more preferably equal to or higher than 2.4.

Furthermore, from the viewpoint of improving the adhesion properties between a coating and an ingredient, the degree of swelling in cold water of the component (A) is lower than 3.5, preferably equal to or lower than 3.2, more preferably equal to or lower than 3.0, even more preferably equal to or lower than 2.8, and still more preferably equal to or lower than 2.6.

The method for measuring the degree of swelling in cold water of the component (A) and the component (B), which will be described later, will be explained later in the section of examples.

The component (A) is preferably one kind of starch or two or more kinds of starches selected from the group consisting of a maize starch such as a corn starch, a waxy corn starch, or a high-amylose corn starch; a potato starch; a wheat starch; a tapioca starch; and a processed starch thereof, more preferably one kind of starch or two or more kinds of starches selected from the group consisting of a corn starch, a waxy corn starch, a distarch phosphate from tapioca starch (phosphoric acid cross-linked tapioca starch), an acetylated distarch phosphate from tapioca starch (acetylated cross-linked tapioca starch), and an etherified tapioca starch, and even more preferably a corn starch.

(Component (B))

The component (B) is a starch having a degree of swelling in cold water of equal to or higher than 3.5 and equal to or lower than 40. More specifically, from the viewpoint of making it difficult for the texture of a coating to vary between the side close to an ingredient and the outer side, the degree of swelling in cold water of the component (B) is equal to or higher than 3.5, preferably equal to or higher than 5, more preferably equal to or higher than 15, even more preferably equal to or higher than 20, and still more preferably equal to or higher than 30.

Furthermore, from the viewpoint of improving the adhesion properties between a coating and an ingredient, the degree of swelling in cold water of the component (B) is equal to or lower than 40, preferably equal to or lower than 38, more preferably equal to or lower than 36, and even more preferably equal to or lower than 34.

The component (B) is preferably a pregelatinized starch.

Examples of sources of the component (B) include the starch derived from plants described above regarding component (A), and the like. The source of the component (A) may be the same as or different from the source of the component (B). The source of the component (B) is preferably a waxy corn.

From the viewpoint of making it difficult for the texture of a coating to vary between the side close to an ingredient and the outer side, a mixing amount of the component (B) in the composition with respect to 100 parts by mass of the component (A) in the composition is equal to or greater than 0.03 parts by mass, preferably equal to or greater than 0.05 parts by mass, more preferably equal to or greater than 0.1 parts by mass, even more preferably equal to or greater than 0.7 parts by mass, still more preferably equal to or greater than 1 part by mass, and yet more preferably equal to or greater than 1.5 parts by mass.

Furthermore, from the viewpoint of improving the adhesion properties between a coating and an ingredient, the mixing amount of the component (B) with respect to 100 parts by mass of the component (A) in the composition is equal to or smaller than 7 parts by mass, preferably equal to or smaller than 5.5 parts by mass, more preferably equal to or smaller than 4.5 parts by mass, and even more preferably equal to or smaller than 3 parts by mass.

From the viewpoint of further stabilizing the adhesion properties between a coating and an ingredient, a total mixing amount of the raw material starch including the components (A) and (B) in the composition with respect to the total amount of the composition is preferably equal to or greater than 80% by mass, more preferably equal to or greater than 84% by mass, even more preferably equal to or greater than 87% by mass, and still more preferably equal to or greater than 90% by mass. From the same viewpoint, the total mixing amount of the raw material starch including the components (A) and (B) in the composition with respect to the total amount of the composition is preferably equal to or smaller than 99.9% by mass, more preferably equal to or smaller than 99.5% by mass, and even more preferably equal to or smaller than 99% by mass.

The raw material starch in the composition is preferably composed of the components (A) and (B). At this time, the content of the components (A) and (B) in the composition with respect to the total amount of the composition is more preferably within the above range.

(Component (C))

The component (C) is at least one of edible oil and fat. Specific examples of the component (C) include soybean oil, safflower oil such as high linoleic safflower oil, corn oil, rapeseed oil, perilla oil, linseed oil, sunflower oil, peanut oil, cottonseed oil, olive oil, rice bran oil, palm oil, and the like. From the viewpoint of operability, liquid oil is preferably used as the edible oil or fat, and one liquid oil or two or more liquid oils selected from the group consisting of soybean oil, rapeseed oil, corn oil, high linoleic safflower oil, linseed oil, and perilla oil are more preferable.

As the edible oil or fat, oil or fat having an iodine value equal to or higher than 100 are more preferably used, and oil or fat having an iodine value equal to or higher than 135 are even more preferably used. The oil or fat with a high iodine value are readily oxidized by heating and are highly effective for modifying the raw material starch. Therefore, the oil or fat are expected to more effectively improve the adhesion properties with respect to an ingredient in a case where the oil or fat are mixed with a coating material. Specifically, examples of the oil or fat with an iodine value equal to or higher than 135 include high linoleic safflower oil, linseed oil, and perilla oil. The upper limit of the iodine value of the edible oil or fat is not limited, but is equal to or lower than 250 for example.

From the viewpoint of making it difficult for the texture of a coating to vary between the side close to an ingredient and the outer side, a mixing amount of the component (C) with respect to 100 parts by mass of the component (A) in the composition is preferably equal to or greater than 0.01 parts by mass, more preferably equal to or greater than 0.03 parts by mass, even more preferably equal to or greater than 0.05 parts by mass, and still more preferably equal to or greater than 0.08 parts by mass.

Furthermore, from the viewpoint of improving the adhesion properties between a coating and an ingredient, the mixing amount of the component (C) with respect to 100 parts by mass of the component (A) in the composition is preferably equal to or smaller than 10 parts by mass, more preferably equal to or smaller than 8 parts by mass, even more preferably equal to or smaller than 6 parts by mass, still more preferably equal to or smaller than 3 parts by mass, yet more preferably equal to or smaller than 1 part by mass, and further more preferably equal to or smaller than 0.4 parts by mass.

(Component (D))

The component (D) is a protein material. Examples of the component (D) include a natural protein material with a high plant protein content, a high animal protein content, or the like, a roughly purified protein derived from a natural protein material, a purified protein, and the like. Examples of the plant protein include a wheat protein such as gluten; a seed protein such as a soybean protein or a corn protein; and the like. Examples of the animal protein include an egg protein such as an egg white protein or an egg yolk protein; a milk protein such as a whey protein or casein; a blood protein such as a plasma protein or a blood cell protein; a muscle protein such as a meat protein or a fish protein, and the like.

From the viewpoint of improving the adhesion properties between a coating and an ingredient and from the viewpoint of making it difficult for the texture of a coating to vary between the side close to an ingredient and the outer side, the component (D) preferably contains one kind of protein or two or more kinds of proteins selected from the group consisting of a plant protein and an animal protein, more preferably contains one kind of protein or two or more kinds of proteins selected from the group consisting of a soybean protein, an egg protein, and a wheat protein, and even more preferably contains a soybean protein. Examples of protein materials containing the soybean protein include defatted soybean flour, full-fat soybean flour, a concentrated soybean protein, an isolated soybean protein, and the like. Among these, defatted soybean flour is preferable.

From the viewpoint of improving the adhesion properties between a coating and an ingredient and from the viewpoint of making it difficult for the texture of a coating to vary between the side close to an ingredient and the outer side, a mixing amount of the component (D) with respect to 100 parts by mass of the component (A) in the composition is preferably equal to or greater than 0.1 parts by mass, more preferably equal to or greater than 0.2 parts by mass, even more preferably equal to or greater than 0.4 parts by mass, and still more preferably equal to or greater than 0.6 parts by mass.

Furthermore, from the same viewpoint, the mixing amount of the component (D) with respect to 100 parts of the component (A) in the composition is preferably equal to or smaller than 10 parts by mass, more preferably equal to or smaller than 8 parts by mass, even more preferably equal to or smaller than 6 parts by mass, and still more preferably equal to or smaller than 4 parts by mass.

Next, a method for manufacturing the starch processed with oil or fat of the present embodiment will be described.

The starch processed with oil or fat is obtainable, for example, by a manufacturing method including the following steps by using the components (A) to (D) described above and other components as appropriate.

(First step) preparing a composition containing the components (A) to (D) by mixing these components together

(Second step) performing a heating treatment on the composition obtained by the first step

In the first step, the order of mixing the components together is not limited. It is preferable that the components other than the component (C) are mixed together, and then the component (C) is added to and mixed with the mixture.

In the second step, by heating the composition obtained by the first step, the starch processed with oil or fat is obtainable.

From the viewpoint of further stabilizing the adhesion properties between a coating and an ingredient, the heating treatment is preferably performed at a temperature equal to or lower than 130° C., more preferably performed at a temperature equal to or lower than 120° C., even more preferably performed at a temperature equal to or lower than 105° C., and still more preferably performed at a temperature equal to or lower than 90° C. The lower limit of the heating temperature is not limited. However, from the viewpoint of improving productivity by appropriately reducing the duration of the heating treatment, lower limit of the heating temperature is, for example, equal to or higher than 40° C., preferably equal to or higher than 45° C., and more preferably equal to or higher than 55° C.

The duration of the heating treatment is appropriately set according to the state of the starch processed with oil or fat to be obtained and the heating temperature. From the viewpoint of further stabilizing the adhesion properties between a coating and an ingredient, the duration of the heating treatment is, for example, equal to or longer than 0.5 hours, preferably equal to or longer than 5 hours, more preferably equal to or longer than 6 hours, and even more preferably equal to or longer than 24 hours. From the same viewpoint, the upper limit of the duration of the heating treatment is, for example, equal to or shorter than 25 days, preferably equal to or shorter than 20 days, and more preferably equal to or shorter than 18 days.

The starch processed with oil or fat is obtainable through the procedure described above. The obtainable starch processed with oil or fat is suitable for a coating material for deep-fried foods such as predust or batter. Specifically, the starch processed with oil or fat is more suitable for a coating material provided between an ingredient and the outermost layer of a coating.

The coating material for deep-fried foods of the present embodiment contains the starch processed with oil or fat of the present embodiment described above.

The predust is a coating material which is used in combination with batter and used on more interior side (side closer to an ingredient) than the batter. For example, the predust is used for an ingredient to which batter has not yet been attached. In a case where the predust is used for an ingredient from which a coating is easily peeled, such as meat or a fishery product having undergone a heating treatment, it is possible to more effectively suppress the peeling that occurs between the coating and the ingredient.

In the present embodiment, from the viewpoint of improving the adhesion properties between a coating and an ingredient and from the viewpoint of making it difficult for the texture of a coating to vary between the side close to an ingredient and the outer side, the content of the starch processed with oil or fat in the predust with respect to the total amount of the predust is preferably equal to or greater than 50% by mass, and more preferably equal to or greater than 80% by mass. The upper limit thereof is not limited, and is equal to or smaller than 100% by mass for example.

The batter is a liquid coating material. The batter is directly attached to an ingredient or attached to a predusted ingredient. In the present embodiment, the batter is used in combination with another coating material such as bread crumbs or breader, and used on more interior side (side closer to the ingredient) than another coating material described above.

In the present embodiment, from the viewpoint of improving the adhesion properties between a coating and an ingredient and from the viewpoint of making it difficult for the texture of a coating to vary between the side close to an ingredient and the outer side, the content of the starch processed with oil or fat in the batter with respect to a solid contents in the batter is preferably equal to or greater than 50% by mass, and more preferably equal to or greater than 70% by mass. The upper limit thereof is not limited and is equal to or smaller than 100% by mass for example.

The coating material may contain components other than the starch processed with oil or fat of the present embodiment. Examples of those other components include starches other than the starch processed with oil or fat of the present embodiment, such as a corn starch; polysaccharides other than the above, such as xanthan gum, or other viscosity adjusters; cereal powder such as wheat flour, rice flour, or corn flour; a protein such as a soybean protein, a milk protein, egg white, or egg yolk; flavorings such as Mirin, soy sauce, salt, and spices; oils and fats such as plant and animal oil or fat and powdered oil or fat; an emulsifier such as lecithin or a glycerin fatty acid ester; and a leavening agent such as baking powder.

The food according to the present embodiment contains or is obtainable by using the coating material for deep-fried foods of the present embodiment. More specifically, the food is obtainable by attaching the coating material for deep-fried foods according to the present embodiment to an ingredient. That is, the food according to the present embodiment is specifically a food which is a fried deep-fried food(-like) food.

More specifically, the food according to the present embodiment contains an ingredient, a coating material (I) provided on the outside of the ingredient, and a coating material (II) provided on the outermost side. The coating material (I) contains the starch processed with oil or fat according to the present embodiment, and the coating material (II) substantially does not contain the starch processed with oil or fat according to the present embodiment. For the coating material (II), “substantially does not contain the starch processed with oil or fat according to the present embodiment” means that the starch processed with oil or fat according to the present embodiment is intentionally not mixed with the coating material (II).

The food according to the present embodiment may be provided with a plurality of coating materials other than the coating material (I) and the coating material (II) or may be provided with a plurality of coating materials (I). Furthermore, the food according to the present embodiment may be provided with a coating material other than the coating material (I) and the coating material (II) that is beneath the coating material (I). From the viewpoint of improving the adhesion properties between a coating and an ingredient, it is preferable that the coating material (I) is provided directly on the surface of the ingredient.

Examples of combinations including the coating material (I) and the coating material (II) include a combination in which the coating material (I) is predust and the coating material (II) is batter; a combination in which the coating material (I) is at least one or more of predust and batter and the coating material (II) is bread crumbs; a combination in which the coating material (I) is at least one or more of predust and batter and the coating material (II) is breader; a combination in which the coating material (I) is batter and the coating material (II) is bread crumbs; and a combination in which the coating material (I) is batter and the coating material (II) is breader, and the like.

The method for manufacturing a food according to the present embodiment includes, for example, attaching the coating material (I), which contains the starch processed with oil or fat according to the present embodiment, to the outside of an ingredient, and attaching the coating material (II), which substantially does not contain the starch processed with oil or fat according to the present embodiment, to the outermost side of a food after the attaching the coating material (I).

The method for manufacturing a food according to the present embodiment may further include performing heat cooking after the attaching the coating material (II).

The cooking method at the time of performing the heat cooking is not limited. For example, the cooking method can be used for deep-fried foods obtainable by frying the coating material according to the present embodiment or can be used for so-called non-fried foods which are in other words deep-fried food-like foods. Specific examples of the deep-fried food-like foods include foods obtainable by being baked in an oven or heated with steam.

Examples of the food according to the present embodiment include fried foods having a bread crumb coating; Kara-age-like foods such as Kara-age and Tatsuta-age; Tempura-like foods such as Tempura and Kaki-age; and fritters.

More specifically, examples of the fried foods having a bread crumb coating include croquettes such as a potato croquette and a cream croquette, a pork cutlet, a ground meat cutlet, a beef cutlet, a chicken cutlet, a ham cutlet, and fried fishery products such as fried shrimp and fried squid.

Specific examples of ingredients to which the coating material for deep-fried foods will be attached include meat such as pork, chicken, and beef; meat processed products; shellfish such as shrimps, squids, oysters, and scallops; fish such as horse mackerels; other seafoods; processed fishery products such as seafood paste; and fresh product such as vegetables.

At the time of actually manufacturing foods, from the viewpoint of hygiene, meat is subjected to a heating treatment (for example, a steam treatment). The adhesion properties between the meat having undergone the heating treatment and a coating are apparently poorer than the adhesion properties between raw meat and a coating. However, from the coating material according to the present embodiment, sufficient adhesion properties can be obtained, for example, even for the meat having undergone the heating treatment.

### EXAMPLES

First, raw materials used in the following examples will be described.

(Starch having degree of swelling in cold water of lower than 3.5)

Corn starch: J-Oil MILLS corn starch Y, manufactured by J-Oil MILLS, INC., degree of swelling in cold water: 2.58

Waxy corn starch: J-Oil MILLS waxy corn starch Y, manufactured by J-Oil MILLS, INC., degree of swelling in cold water: 2.68

High-amylose corn starch: J-Oil MILLS HS-7, manufactured by J-Oil MILLS, INC., degree of swelling in cold water: 2.96

Potato starch: JELCALL BP-200, manufactured by J-Oil MILLS, INC., degree of swelling in cold water: 2.23

Wheat starch: WS-525, manufactured by Chiba Flour Milling Co., Ltd., degree of swelling in cold water: 2.33

Distarch phosphate tapioca starch: ACTBODY TP-1, manufactured by J-Oil MILLS, INC., degree of swelling in cold water: 2.09

Acetylated tapioca starch: ACTBODY A-700, manufactured by J-Oil MILLS, INC., degree of swelling in cold water: 2.28

Acetylated distarch phosphate tapioca starch: ACTBODY ATP-27, manufactured by J-Oil MILLS, INC., degree of swelling in cold water: 2.22

Etherified tapioca starch: JELCALL POT-05, manufactured by J-Oil MILLS, INC., degree of swelling in cold water: 2.32

Wet heat treated corn starch: NISSHOKU ROADSTAR manufactured by NIHON SHOKUHIN KAKO CO., LTD., degree of swelling in cold water: 2.77

(Starch having degree of swelling in cold water of equal to or higher than 3.5)

α-Waxy corn starch: manufactured by J-Oil MILLS, INC., degree of swelling in cold water: 33.0

Pregelatinized corn starch: obtained in Manufacturing Example 1, degree of swelling in cold water: 9.8

AH-F: JELCALL AH-F, manufactured by J-Oil MILLS, INC., degree of swelling in cold water: 6.5

GT-α: JELCALL GT-α, manufactured by J-Oil MILLS, INC., degree of swelling in cold water: 14.1

(Edible Oil or Fat)

High linoleic safflower oil (iodine value: 145): manufactured by Summit oil mill

Soybean oil (iodine value: 132): refined soybean oil, manufactured by J-Oil MILLS, INC.

(Protein Material)

Defatted soybean flour: Nikka Milky S, manufactured by J-Oil MILLS, INC.

Dried egg white: dried egg white W type, manufactured by Kewpie Corporation

Gluten: A-GLU GB, manufactured by GLICO NUTRITION CO., LTD.

For the raw materials described above, a degree of swelling in cold water was measured by the following method.

(Method for Measuring Degree of Swelling in Cold Water)

By the method described in “Testing Method for Starch and Related Carbohydrates”, pp. 279-280, 1986, Gakkai Shuppan Center”, the degree of swelling in cold water was measured. Specifically, the degree of swelling in cold water was measured by the following method.

(1) By using a moisture analyzer (manufactured by Kensei Co., LTD., electromagnetic moisture analyzer: MX50 model), a sample was dried by being heated at 125° C., a moisture content thereof was measured, and the mass of a dried substance was calculated from the obtained moisture content.

(2) A sample was weighed out in an amount of 1 g expressed in terms of the mass of the dried substance, put into a centrifuge tube, and impregnated with 1 mL of methyl alcohol. The sample was stirred with a glass rod, and in this state, distilled water with a temperature of 25° C. was added thereto such that the volume thereof exactly became 50 mL. The obtained solution was shaken occasionally and left to stand for 20 minutes at 25° C. The solution was subjected to centrifugation for 30 minutes at 25° C. and 4,500 rpm, and by tilting the centrifuge tube, the supernatant was collected into a weighing bottle. The supernatant collected into the weighing bottle was dried by evaporation, further dried under reduced pressure for 3 hours at 110° C., and weighed, thereby determining the dry mass of the supernatant. Furthermore, the mass of precipitates was determined, the solubility was calculated by the following equation, and then a degree of swelling in cold water was calculated.

Solubility (S) db %=dry mass of supernatant (mg)/1,000×100

Degree of swelling in cold water=mass of precipitates (mg)/(1,000×(100−S)/100)

### (Manufacturing Example 1) Method for Manufacturing Pregelatinized Corn Starch

A corn starch (100 parts by mass) was mixed with 200 parts by mass of water with stirring, thereby preparing a slurry. Furthermore, in a state of being stirred, the slurry was gelatinized using an onlator (hot-cold cylinder) (outlet temperature: about 100° C.). The gelatinized solution was immediately spread thin on a drum drier by a common method, dried by being heated at 150° C., and then ground using a grinder, thereby obtaining a pregelatinized corn starch.

### Examples 1 to 27 and Comparative Examples 1 to 6

The composition obtained by mixing together the raw materials described in Table 1 to Table 4 was processed with oil or fat, thereby manufacturing a starch processed with oil or fat. That is, the raw materials (unit: part by mass) of a starch to be processed with oil or fat described in Table 1 to Table 4 were uniformly mixed together for 3 minutes at 2,000 rpm by using a mixer (super mixer, manufactured by KAWATA MFG CO., LTD.), thereby obtaining a mixture (moisture content: 12.5% by mass).

The mixture was dried for 14 days at 70° C. by using a tray drier, thereby obtaining a starch processed with oil or fat of each of the examples.

For Examples 1 to 27 and Comparative Examples 1 to 3, 5, and 6, a food was manufactured using the obtained starch processed with oil or fat as a raw material of a coating material, and the food was evaluated.

For Comparative Example 4, a food was manufactured using a mixture of the obtained starch processed with oil or fat and the pregelatinized corn starch as a raw material of a coating material, and the food was evaluated. A mixing amount of the pregelatinized corn starch with respect to 100 parts by mass of the corn starch as a raw material of the starch processed with oil or fat was 2 parts by mass (Table 1).

The food was manufactured and evaluated by the following methods.

(Method for Manufacturing Pork Cutlet)

The starch processed with oil or fat of each of the examples (for Comparative Example 4, a mixture of the starch processed with oil or fat and the pregelatinized corn starch described in Table 1) (90 g), 9.6 g of a corn starch, and 0.4 g of xanthan gum (ECHOGUM F, manufactured by DSP GOKYO FOOD & CHEMICAL Co., Ltd.) were thoroughly mixed together, and then 200 g of ice-cooled water was added to and mixed with the mixture. The obtained mixture was used as batter.

Frozen pork (about 80 g) was put in the batter, coated with bread crumbs, and then preserved overnight in a frozen state. Thereafter, the pork was deep-fried for 5 minutes in canola oil at 170° C., thereby obtaining a pork cutlet.

(Method for Evaluating Pork Cutlet)

<Evaluation of Adhesion Properties of Pork Cutlet>

One minute after being deep-fried, the pork cutlet was cut into 5 equal parts. For four cut faces thereof, 1 point was given to a cut face in which peeling did not occur between the coating and the ingredient, 0.5 points were given to a cut face in which peeling partially occurred, and 0 point was given to a cut surface in which the coating was completely peeled from the ingredient.

For two sheets of pork cutlets, a total of 8 cut faces were evaluated (on a maximum of 8 points). A value of (total score of 8 cut faces evaluated/8 points×100) (%) was calculated, and a sample obtaining a score equal to or higher than 80% was regarded as being acceptable.

<Evaluation of Texture of Pork Cutlet in Coating>

Three professional panels were asked to eat the cut pork cutlets evaluated as described in “Adhesion properties of pork cutlet”, and evaluate the difference in texture between the bread crumb layer and the non-bread crumb layer in the coating on five scales of A to E according to the following evaluation standards on the basis of consensus. Samples graded A, B, and C were regarded as being acceptable.

A (difference is not felt): the non-bread crumb layer is very soft and does not have texture that feels different from the crispiness of the bread crumb layer.

B (difference is felt little): although the non-bread crumb layer is sticky and dense, because the non-bread crumb layer is soft, the texture of the non-bread crumb layer substantially does not feel different from the crispiness of the bread crumb layer.

C (not much difference is felt): although the non-bread crumb layer is sticky and dense, because the non-bread crumb layer is slightly soft, the texture of the non-bread crumb layer does not feel greatly different from the crispiness of the bread crumb layer.

D (difference is rather felt): the non-bread crumb layer is slightly hard, and the texture of the non-bread crumb layer feels feel slightly different from the crispiness of the bread crumb layer.

E (difference is felt): the non-bread crumb layer is hard, and the texture of the non-bread crumb layer feels very different from the crispiness of the bread crumb layer.

(Method for Manufacturing Ham Cutlet)

A ham cutlet was manufactured and obtained by the same method as that used for manufacturing the pork cutlets, except that the frozen pork in “Method for manufacturing pork cutlet” was made into Bologna sausages cut in a thickness of about 1 cm (TOPVALU bologna sausage, manufactured by AEON CO., LTD.), and deep-fried for 3 minutes.

<Method for Evaluating Ham Cutlet>

(Evaluation of Adhesion Properties of Ham Cutlet)

One minute after being deep-fried, the ham cutlet was cut into 5 equal parts. For 4 cut faces thereof, 1 point was given to a cut face in which peeling did not occur between the coating and the ingredient, 0.5 points were given to a cut face in which peeling partially occurred, and 0 point was given to a cut surface in which the coating was completely peeled from the ingredient.

For 4 sheets of ham cutlets, a total of 16 cut faces were evaluated (on a maximum of 16 points). A value of (total score of 16 cut faces evaluated/16 points×100) (%) was calculated, and a sample obtaining a score equal to or higher than 60% was regarded as being acceptable.

<Evaluation of Texture of Ham Cutlet in Coating>

The texture of the ham cutlet in the coating was evaluated by the same method as that used for evaluating the texture of the pork cutlet in the coating.

(Method for Manufacturing Croquette)

The starch processed with oil or fat of each of the examples (90 g), 9.6 g of a corn starch, and 0.4 g of xanthan gum (ECHOGUM F, manufactured by DSP GOKYO FOOD & CHEMICAL Co., Ltd.) were thoroughly mixed together, and then 200 g of ice-cooled water was added to and mixed with the mixture. The obtained mixture was used as batter.

Boiling water (120 parts by mass) was poured on 35 parts by mass of dried mashed potato (JAGAMASH, manufactured by Calbee Potato, Inc.), and the mashed potato were thoroughly mixed with the water and then molded, thereby obtaining molded mashed potato (about 40 g).

The molded mashed potato was put in the batter, coated with bread crumbs, preserved overnight in a frozen state, and then deep-fried for 4 minutes in canola oil at 170° C., thereby obtaining a croquette.

(Method for Evaluating Croquette)

<Evaluation of Adhesion Properties of Croquette>

One minute after being deep-fried, the croquette was cut into 3 equal pieces. For 2 cut faces thereof, 1 point was given to a cut face in which peeling did not occur between the coating and the ingredient, 0.5 points were given to a cut face in which peeling partially occurred, and 0 point was given to a cut face in which the coating was completely peeled from the ingredient.

For 7 croquettes, a total of 14 cut faces were evaluated (on a maximum of 14 points). A value of (total score of 14 cut faces evaluated/14 points×100) (%) was calculated, and a sample obtaining a score equal to or higher than 80% was regarded as being acceptable.

<Evaluation of Texture of Croquette in Coating>

The texture of the croquette in the coating was evaluated by the same method as that used for evaluating the texture of the pork cutlet in the coating.

(Method for Manufacturing Shrimp Tempura)

Tail-on stretched shrimps (about 13 g/one shrimp) that were thawed were coated with the starch processed with oil or fat of each of the examples as a predust in an amount of about 3 parts by mass with respect to 100 parts by mass of the shrimps.

The shrimps coated with the predust were put in a batter (liquid obtained by mixing together about 100 parts by mass of soft flour, 50 parts by mass of liquid egg, and 100 parts by mass of ice-cooled water) and deep-fried for 3 minutes in canola oil at 170° C., thereby obtaining shrimp Tempuras.

(Method for Evaluating Shrimp Tempura)

<Evaluation of Adhesion Properties of Shrimp Tempura>

One minute after being deep-fried, each of the shrimp Tempuras was cut in half lengthwise from the head to the tail. For the cut faces, 1 point was given to a cut face in which peeling did not occur between the coating and the ingredient, 0.5 points were given to a cut face in which peeling partially occurred, and 0 point was given to a cut surface in which the coating was completely peeled from the ingredient.

For 4 shrimp Tempuras, a total of 4 cut faces were evaluated (on a maximum of 4 points). A value of (total score of 4 cut faces evaluated/4 points×100) (%) was calculated, and a sample obtaining a score equal to or higher than 60% was regarded as being acceptable.

<Evaluation of Texture of Shrimp Tempura in Coating>

Three professional panels were asked to eat the cut shrimp Tempuras evaluated as described in “Adhesion properties of shrimp Tempura”, and evaluate the difference in texture between the batter layer and the predust layer in the coating on five scales of A to E according to the following evaluation standards on the basis of consensus. Samples graded A, B, and C were regarded as being acceptable.

A (difference is not felt): the predust layer is very soft and does not have texture that feels different from the crispiness of the batter layer.

B (difference is felt little): although the predust layer is sticky and dense, because the predust layer is soft, the texture of the predust layer substantially does not feel different from the crispiness of the batter layer.

C (not much difference is felt): although the predust layer is sticky and dense, because the predust layer is slightly soft, the texture of the predust layer does not feel greatly different from the crispiness of the batter layer.

D (difference is rather felt): the predust layer is slightly hard, and the texture of the predust layer feels feel slightly different from the crispiness of the batter layer.

E (the texture of the predust layer feels different from the texture of the batter layer): the predust layer is hard, and the texture of the predust layer feels very different from the crispiness of the batter layer.

TABLE 1

| | | | Degree of | Compar- | Compar- | Compar- | Compar- | | |
|---|---|---|---|---|---|---|---|---|---|
| | | | swelling | ative | ative | ative | ative | | |
| | | | in cold | Example | Example | Example | Example | Example | Example |
| Component | | Sample name | water | 1 | 2 | 3 | 4 | 1 | 2 |
| Raw | Starch | Corn starch | 2.58 | 100 | 100 | 100 | 100 | 100 | 100 |
| materials | having | Waxy corn | 2.68 | | | | | | |
| of starch | degree of | starch | | | | | | | |
| processed | swelling | High amylose | 2.96 | | | | | | |
| with oil | in cold | corn starch | | | | | | | |
| or fat | water of | Potato starch | 2.23 | | | | | | |
| | lower | Wheat starch | 2.33 | | | | | | |
| | than 3.5 | Distarch | 2.09 | | | | | | |
| | | phosphate | | | | | | | |
| | | tapioca starch | | | | | | | |
| | | Acetylated | 2.28 | | | | | | |
| | | tapioca starch | | | | | | | |
| | | Acetylated | 2.22 | | | | | | |
| | | distarch | | | | | | | |
| | | phosphate | | | | | | | |
| | | tapioca starch | | | | | | | |
| | | Etherified | 2.32 | | | | | | |
| | | tapioca starch | | | | | | | |
| | | Wet heat | 2.77 | | | | | | |
| | | treated corn | | | | | | | |
| | | starch | | | | | | | |
| | Edible oil | High linoleic | — | 0.1 | 0.1 | 0.1 | 0.1 | 0.1 | 0.1 |
| | or fat | safflower oil | | | | | | | |
| | | (iodine value: | | | | | | | |
| | | 145) | | | | | | | |
| | | Soybean oil | — | | | | | | |
| | | (iodine value: | | | | | | | |
| | | 132) | | | | | | | |
| | Starch | α-Waxy corn | 33.0 | 0 | 0 | 2 | 0 | 2 | 2 |
| | having | starch | | | | | | | |
| | degree of | Pregelatinized | 9.8 | | | | | | |
| | swelling | starch | | | | | | | |
| | in cold | AH-F | 6.5 | | | | | | |
| | water of | GT-α | 14.1 | | | | | | |
| | equal to | | | | | | | | |
| | or higher | | | | | | | | |
| | than 3.5 | | | | | | | | |
| | Protein | Defatted | — | 0 | 1 | 0 | 0 | 1 | 1 |
| | material | soybean flour | | | | | | | |
| | | Dried egg | — | | | | | | |
| | | white | | | | | | | |
| | | Gluten | — | | | | | | |
| Others | | Pregelatinized | 9.8 | | | | | | |
| | | corn starch | | | | | | | |
| Evaluation | Ingre- | Adhesion properties | | 38 | 75 | 63 | 38 | 81 | 100 |
| result | dient + | of pork cutlet % | | | | | | | |
| | batter + | Difference in texture | | E | E | D | D | B | A |
| | bread | between bread crumb | | | | | | | |
| | crumbs | layer and non-bread | | | | | | | |
| | (starch | crumb layer in coating | | | | | | | |
| | processed | Adhesion properties | | 38 | 56 | 56 | | | 72 |
| | with oil or | of ham cutlet % | | | | | | | |
| | fat in each | Difference in texture | | E | E | D | | | C |
| | example | between bread crumb | | | | | | | |
| | was used | layer and non-bread | | | | | | | |
| | in batter.) | crumb layer in coating | | | | | | | |
| | | Adhesion properties of | | 61 | 68 | 75 | | | 100 |
| | | croquette % | | | | | | | |
| | | Difference in texture | | E | E | D | | | C |
| | | between bread crumb | | | | | | | |
| | | layer and non-bread | | | | | | | |
| | | crumb layer in coating | | | | | | | |
| | Ingre- | Adhesion properties | | 25 | 38 | 38 | | | 63 |
| | dient + | of shrimp Tempura % | | | | | | | |
| | predust + | Difference in texture | | E | E | D | | | A |
| | batter | between batter layer | | | | | | | |
| | (starch | and predust layer | | | | | | | |
| | processed | in coating | | | | | | | |
| | with oil or | | | | | | | | |
| | fat in each | | | | | | | | |
| | example | | | | | | | | |
| | was used | | | | | | | | |
| | in predust.) | | | | | | | | |

TABLE 2

| | | | Degree of | | | | | | | | | Compar- |
|---|---|---|---|---|---|---|---|---|---|---|---|---|
| | | | swelling | Ex- | Ex- | Ex- | Ex- | Ex- | Ex- | Ex- | Ex- | ative |
| | | | in cold | ample | ample | ample | ample | ample | ample | ample | ample | Example |
| Component | | Sample name | water | 3 | 4 | 5 | 6 | 7 | 8 | 9 | 10 | 5 |
| Raw | Starch | Corn starch | 2.58 | 100 | 100 | 100 | 100 | 100 | 100 | 100 | 100 | 100 |
| materials | having | Waxy corn | 2.68 | | | | | | | | | |
| of starch | degree of | starch | | | | | | | | | | |
| processed | swelling | High amylose | 2.96 | | | | | | | | | |
| with oil | in cold | corn starch | | | | | | | | | | |
| or fat | water of | Potato starch | 2.23 | | | | | | | | | |
| | lower | Wheat starch | 2.33 | | | | | | | | | |
| | than 3.5 | Distarch | 2.09 | | | | | | | | | |
| | | phosphate | | | | | | | | | | |
| | | tapioca starch | | | | | | | | | | |
| | | Acetylated | 2.28 | | | | | | | | | |
| | | tapioca starch | | | | | | | | | | |
| | | Acetylated | 2.22 | | | | | | | | | |
| | | distarch | | | | | | | | | | |
| | | phosphate | | | | | | | | | | |
| | | tapioca starch | | | | | | | | | | |
| | | Etherified | 2.32 | | | | | | | | | |
| | | tapioca starch | | | | | | | | | | |
| | | Wet heat | 2.77 | | | | | | | | | |
| | | treated corn | | | | | | | | | | |
| | | starch | | | | | | | | | | |
| | Edible oil | High linoleic | — | 0.2 | 0.5 | 1 | 5 | 0.1 | 0.1 | 0.1 | 0.1 | 0.1 |
| | or fat | safflower oil | | | | | | | | | | |
| | | (iodine value: | | | | | | | | | | |
| | | 145) | | | | | | | | | | |
| | | Soybean oil | — | | | | | | | | | |
| | | (iodine value: | | | | | | | | | | |
| | | 132) | | | | | | | | | | |
| | Starch | α-Waxy corn | 33.0 | 2 | 2 | 2 | 2 | 0.1 | 0.5 | 1 | 4 | 10 |
| | having | starch | | | | | | | | | | |
| | degree of | Pregelatinized | 9.8 | | | | | | | | | |
| | swelling | starch | | | | | | | | | | |
| | in cold | AH-F | 6.5 | | | | | | | | | |
| | water of | GT-α | 14.1 | | | | | | | | | |
| | equal to | | | | | | | | | | | |
| | or higher | | | | | | | | | | | |
| | than 3.5 | | | | | | | | | | | |
| | Protein | Defatted | — | 1 | 1 | 1 | 1 | 1 | 1 | 1 | 1 | 1 |
| | material | soybean flour | | | | | | | | | | |
| | | Dried egg | — | | | | | | | | | |
| | | white | | | | | | | | | | |
| | | Gluten | — | | | | | | | | | |
| Others | | Pregelatinized | 9.8 | | | | | | | | | |
| | | corn starch | | | | | | | | | | |

| | | | | | | | | | | | |
|---|---|---|---|---|---|---|---|---|---|---|---|
| Evaluation | Ingre- | Adhesion properties | 88 | 88 | 88 | 81 | 94 | 94 | 94 | 81 | 69 |
| result | dient + | of pork cutlet % | | | | | | | | | |
| | batter + | Difference in texture | B | C | C | C | C | C | B | B | D |
| | bread | between bread crumb | | | | | | | | | |
| | crumbs | layer and non-bread | | | | | | | | | |
| | (starch | crumb layer in coating | | | | | | | | | |
| | processed | | | | | | | | | | |
| | with oil or | | | | | | | | | | |
| | fat in each | | | | | | | | | | |
| | example | | | | | | | | | | |
| | was used | | | | | | | | | | |
| | in batter.) | | | | | | | | | | |

TABLE 3

| | | | Degree of | | | | | | | | | |
|---|---|---|---|---|---|---|---|---|---|---|---|---|
| | | | swelling | Ex- | Ex- | Ex- | Ex- | Ex- | Ex- | Ex- | Ex- | Ex- |
| | | | in cold | ample | ample | ample | ample | ample | ample | ample | ample | ample |
| Component | | Sample name | water | 11 | 12 | 13 | 14 | 15 | 16 | 17 | 18 | 19 |
| Raw | Starch | Corn starch | 2.58 | 100 | 100 | 100 | | | | | | |
| materials | having | Waxy corn | 2.68 | | | | 100 | | | | | |
| of starch | degree of | starch | | | | | | | | | | |
| processed | swelling | High amylose | 2.96 | | | | | 100 | | | | |
| with oil | in cold | corn starch | | | | | | | | | | |
| or fat | water of | Potato starch | 2.23 | | | | | | 100 | | | |
| | lower | Wheat starch | 2.33 | | | | | | | 100 | | |
| | than 3.5 | Distarch | 2.09 | | | | | | | | 100 | |
| | | phosphate | | | | | | | | | | |
| | | tapioca starch | | | | | | | | | | |
| | | Acetylated | 2.28 | | | | | | | | | 100 |
| | | tapioca starch | | | | | | | | | | |
| | | Acetylated | 2.22 | | | | | | | | | |
| | | distarch | | | | | | | | | | |
| | | phosphate | | | | | | | | | | |
| | | tapioca starch | | | | | | | | | | |
| | | Etherified | 2.32 | | | | | | | | | |
| | | tapioca starch | | | | | | | | | | |
| | | Wet heat | 2.77 | | | | | | | | | |
| | | treated corn | | | | | | | | | | |
| | | starch | | | | | | | | | | |
| | Edible oil | High linoleic | — | 0.1 | 0.1 | 0.1 | 0.1 | 0.1 | 0.1 | 0.1 | 0.1 | 0.1 |
| | or fat | safflower oil | | | | | | | | | | |
| | | (iodine value: | | | | | | | | | | |
| | | 145) | | | | | | | | | | |
| | | Soybean oil | — | | | | | | | | | |
| | | (iodine value: | | | | | | | | | | |
| | | 132) | | | | | | | | | | |
| | Starch | α-Waxy corn | 33.0 | 2 | 2 | 2 | 2 | 2 | 2 | 2 | 2 | 2 |
| | having | starch | | | | | | | | | | |
| | degree of | Pregelatinized | 9.8 | | | | | | | | | |
| | swelling | starch | | | | | | | | | | |
| | in cold | AH-F | 6.5 | | | | | | | | | |
| | water of | GT-α | 14.1 | | | | | | | | | |
| | equal to | | | | | | | | | | | |
| | or higher | | | | | | | | | | | |
| | than 3.5 | | | | | | | | | | | |
| | Protein | Defatted | — | 0.5 | 2 | 5 | 1 | 1 | 1 | 1 | 1 | 1 |
| | material | soybean flour | | | | | | | | | | |
| | | Dried egg | — | | | | | | | | | |
| | | white | | | | | | | | | | |
| | | Gluten | — | | | | | | | | | |
| Others | | Pregelatinized | 9.8 | | | | | | | | | |
| | | corn starch | | | | | | | | | | |

| | | | | | | | | | | | |
|---|---|---|---|---|---|---|---|---|---|---|---|
| Evaluation | Ingre- | Adhesion properties | 81 | 88 | 88 | 94 | 81 | 88 | 81 | 94 | 88 |
| result | dient + | of pork cutlet % | | | | | | | | | |
| | batter + | Difference in texture | C | B | C | C | C | C | C | C | C |
| | bread | between bread crumb | | | | | | | | | |
| | crumbs | layer and non-bread | | | | | | | | | |
| | (starch | crumb layer in coating | | | | | | | | | |
| | processed | | | | | | | | | | |
| | with oil or | | | | | | | | | | |
| | fat in each | | | | | | | | | | |
| | example | | | | | | | | | | |
| | was used | | | | | | | | | | |
| | in batter.) | | | | | | | | | | |

TABLE 4

| | | | Degree of | | | | | | | | | Compar- |
|---|---|---|---|---|---|---|---|---|---|---|---|---|
| | | | swelling | Ex- | Ex- | Ex- | Ex- | Ex- | Ex- | Ex- | Ex- | ative |
| | | | in cold | ample | ample | ample | ample | ample | ample | ample | ample | Example |
| Component | | Sample name | water | 20 | 21 | 22 | 23 | 24 | 25 | 26 | 27 | 6 |
| Raw | Starch | Corn starch | 2.58 | | | 100 | 100 | 100 | 100 | 100 | 100 | 100 |
| materials | having | Waxy corn | 2.68 | | | | | | | | | |
| of starch | degree of | starch | | | | | | | | | | |
| processed | swelling | High amylose | 2.96 | | | | | | | | | |
| with oil | in cold | corn starch | | | | | | | | | | |
| or fat | water of | Potato starch | 2.23 | | | | | | | | | |
| | lower | Wheat starch | 2.33 | | | | | | | | | |
| | than 3.5 | Distarch | 2.09 | | | | | | | | | |
| | | phosphate | | | | | | | | | | |
| | | tapioca starch | | | | | | | | | | |
| | | Acetylated | 2.28 | | | | | | | | | |
| | | tapioca starch | | | | | | | | | | |
| | | Acetylated | 2.22 | 100 | | | | | | | | |
| | | distarch | | | | | | | | | | |
| | | phosphate | | | | | | | | | | |
| | | tapioca starch | | | | | | | | | | |
| | | Etherified | 2.32 | | 100 | | | | | | | |
| | | tapioca starch | | | | | | | | | | |
| | | Wet heat | 2.77 | | | | | | | | | 2 |
| | | treated corn | | | | | | | | | | |
| | | starch | | | | | | | | | | |
| | Edible oil | High linoleic | — | 0.1 | 0.1 | | 0.1 | 0.1 | 0.1 | 0.1 | 0.1 | 0.1 |
| | or fat | safflower oil | | | | | | | | | | |
| | | (iodine value: | | | | | | | | | | |
| | | 145) | | | | | | | | | | |
| | | Soybean oil | — | | | 0.1 | | | | | | |
| | | (iodine value: | | | | | | | | | | |
| | | 132) | | | | | | | | | | |
| | Starch | α-Waxy corn | 33.0 | 2 | 2 | 2 | | | | 2 | 2 | 2 |
| | having | starch | | | | | | | | | | |
| | degree of | Pregelatinized | 9.8 | | | | 2 | | | | | |
| | swelling | starch | | | | | | | | | | |
| | in cold | AH-F | 6.5 | | | | | 2 | | | | |
| | water of | GT-α | 14.1 | | | | | | 2 | | | |
| | equal to | | | | | | | | | | | |
| | or higher | | | | | | | | | | | |
| | than 3.5 | | | | | | | | | | | |
| | Protein | Defatted | — | 1 | 1 | 1 | 1 | 1 | 1 | | | 1 |
| | material | soybean flour | | | | | | | | | | |
| | | Dried egg | — | | | | | | | 1 | | |
| | | white | | | | | | | | | | |
| | | Gluten | — | | | | | | | | 1 | |
| Others | | Pregelatinized | 9.8 | | | | | | | | | |
| | | corn starch | | | | | | | | | | |

| | | | | | | | | | | | |
|---|---|---|---|---|---|---|---|---|---|---|---|
| Evaluation | Ingre- | Adhesion properties | 94 | 94 | 81 | 94 | 94 | 94 | 94 | 88 | 50 |
| result | dient + | of pork cutlet % | | | | | | | | | |
| | batter + | Difference in texture | C | C | C | C | C | C | C | C | E |
| | bread | between bread crumb | | | | | | | | | |
| | crumbs | layer and non-bread | | | | | | | | | |
| | (starch | crumb layer in coating | | | | | | | | | |
| | processed | | | | | | | | | | |
| | with oil or | | | | | | | | | | |
| | fat in each | | | | | | | | | | |
| | example | | | | | | | | | | |
| | was used | | | | | | | | | | |
| | in batter.) | | | | | | | | | | |

As shown in Table 1 to Table 4, in each of the examples, when the starch processed with oil or fat was used in batter, an adhesiveness of the batter was excellent, or when the starch processed with oil or fat was used as predust, an adhesiveness of the predust was excellent, also the adhesion properties thereof were excellent. In addition, in each of the examples, it was difficult to feel a difference in texture between the bread crumb layer and the non-bread crumb layer in the coating of the pork cutlet, the ham cutlet or the croquette, or in texture between the batter layer and the predust layer in the coating of the shrimp Tempura, a preferable texture in which the inside of the coating was soft the outside of the coating was crispiness was naturally felt.

The present application claims priority based on Japanese Patent Application No. 2017-186545 field on Sep. 27, 2017, the entire disclosure of which is incorporated into the present specification.

1. A starch processed with oil or fat obtainable by processing a composition with oil or fat,
wherein the composition comprises components (A) a starch having a degree of swelling in cold water of higher than 1 and lower than 3.5, (B) a starch having a degree of swelling in cold water of equal to or higher than 3.5 and equal to or lower than 40, (C) an edible oil or fat, and (D) a protein material, and
a mixing amount of the component (B) with respect to 100 parts by mass of the component (A) in the composition is equal to or greater than 0.03 parts by mass and equal to or smaller than 7 parts by mass.

2. The starch processed with oil or fat according to claim 1,
wherein the component (A) is one kind of starch or two or more kinds of starches selected from the group consisting of a corn starch, a potato starch, a wheat starch, a tapioca starch, and a processed starch thereof.

3. The starch processed with oil or fat according to claim 1,
wherein the component (B) is a pregelatinized starch.

4. The starch processed with oil or fat according to claim 1,
wherein the protein comprised in the component (D) comprises one kind of protein or two or more kinds of proteins selected from the group consisting of a soybean protein, an egg protein, and a wheat protein.

5. The starch processed with oil or fat according to claim 1,
wherein a mixing amount of the component (C) with respect to 100 parts by mass of the component (A) in the composition is equal to or greater than 0.01 parts by mass and equal to or smaller than 10 parts by mass.

6. The starch processed with oil or fat according to claim 1,
wherein a mixing amount of the component (D) with respect to 100 parts by mass of the component (A) in the composition is equal to or greater than 0.1 parts by mass and equal to or smaller than 10 parts by mass.

7. A coating material for deep-fried foods, comprising:
the starch processed with oil or fat according to claim 1.

8. A food comprising:
an ingredient;
a coating material (I) provided on the outside of the ingredient; and
a coating material (II) provided on the outermost side,
wherein the coating material (I) comprises a starch processed with oil or fat obtainable by processing a composition with oil or fat,
wherein the composition comprises components (A) a starch having a degree of swelling in cold water of higher than 1 and lower than 3.5, (B) a starch having a degree of swelling in cold water of equal to or higher than 3.5 and equal to or lower than 40, (C) an edible oil or fat, and (D) a protein material, and
a mixing amount of the component (B) with respect to 100 parts by mass of the component (A) in the composition is equal to or greater than 0.03 parts by mass and equal to or smaller than 7 parts by mass, and
the coating material (II) substantially does not comprise the starch processed with oil or fat.

9. A method for manufacturing a food, comprising:
attaching a coating material (I), which comprises a starch processed with oil or fat according obtainable by processing a composition with oil or fat, to the outside of an ingredient,
wherein the composition comprises components (A) a starch having a degree of swelling in cold water of higher than 1 and lower than 3.5, (B) a starch having a degree of swelling in cold water of equal to or higher than 3.5 and equal to or lower than 40, (C) an edible oil or fat, and (D) a protein material, and
a mixing amount of the component (B) with respect to 100 parts by mass of the component (A) in the composition is equal to or greater than 0.03 parts by mass and equal to or smaller than 7 parts by mass; and
attaching a coating material (II), which substantially does not comprise the starch processed with oil or fat, to the outermost side of a food after the attaching the coating material (I).
